(19) United States
(12) Patent Application Publication
(10) Pub. No.: US 2024/0385063 A1
(43) Pub. Date: Nov. 21, 2024

(54) Force Measuring Device, System and Method for Measuring Web Tensions

(71) Applicant: FMS Force Measuring Systems AG, Oberglatt (CH)

(72) Inventor: Jörg Inhelder, Nürensdorf (CH)

(21) Appl. No.: 18/693,901

(22) PCT Filed: Sep. 13, 2022
(86) PCT No.: PCT/EP2022/075436

§ 371 Date: Mar. 20, 2024

(30) Foreign Application Priority Data
Sep. 21, 2021 (EP) 21197905.9

(51) Int. Cl. G01L 5/108; B65H 23/04

(52) U.S. Cl. CPC G01L 5/108; B65H 23/044; B65H 2515/314; B65H 2553/81

(57) ABSTRACT

The present invention relates to a force measuring device (10) for measuring the web tensions of a plurality of spaced apart longitudinal strips (5) of a longitudinally cut running material web that comprises a longitudinal direction defined by the running direction of the material web and a transverse direction, the force measuring device comprising an axle (12) and, supported on the axle, a measuring roll (20) wrapped around by the material web. Here, it is provided that the measuring roll is formed as a segmented measuring roll (20) having a plurality of measuring segments (22), the measuring segments (22) are arranged on the axle (12) in a respective measuring position, such that the spaced apart longitudinal strips (5) of the running material web wrap around in each case one or more measuring segments (22) and each measuring segment (22) is wrapped around by at most one longitudinal strip (5), each measuring segment (22) includes a dedicated load cell (26) for determining a web tension fraction of the longitudinal strip (5) wrapped around the measuring segment, the load cell providing a mount with which the measuring segment (22) sits on the axle (12), the force measuring device further comprising an evaluation unit (18) to which the measuring segments (22) are connected via electrical conductors and to which the measuring signals supplied by the load cells (26) in the measuring segments (22) are conductible, and the evaluation unit (18) comprising a web tension aggregation means (19) that is arranged and adapted to determine, for each longitudinal strip (5), from the web tension fractions that are determined by the load cells (26) of the measuring segments (22) wrapped around by said longitudinal strip (5), the total web tension of the longitudinal strip (5).

The present invention relates to a force measuring device and a system for measuring web tensions in a longitudinally cut running material web. The present invention also relates to associated methods for measuring web tensions with such a force measuring device or such a system.

In systems for manufacturing or further processing web-shaped materials, such as paper, plastic foils, aluminum foils or foils for batteries or capacitors, at the beginning of the processing operation, the material webs are processed having web widths of a few meters. For further processing, for example in label printing or packaging production, often significantly narrower webs are needed, and for this, the material webs are cut into narrower longitudinal strips of the desired width on slitter winders. Conventional force measuring devices measure the web tension of a material web across the full web width, but for the further processing of cut webs, it would be advantageous to obtain more precise details about the web tension in each of the longitudinal strips of a cut web.

This is where the present invention begins. The object of the present invention, as characterized in the claims, is to specify a force measuring device of the kind mentioned above with which the web tensions of a plurality of longitudinal strips of a longitudinally cut running material web can be measured. The present invention is also intended to provide an associated method for measuring web tensions in a longitudinally cut running material web.

Said object is solved by the features of the independent claims. Developments of the present invention are the subject of the dependent claims.

The present invention provides a force measuring device for measuring the web tensions of a plurality of spaced apart longitudinal strips of a longitudinally cut running material web that comprises a longitudinal direction defined by the running direction of the material web and a transverse direction. The force measuring device comprises an axle and, supported on the axle, a measuring roll wrapped around by the material web. In the case of the force measuring device, it is provided that
the measuring roll is formed as a segmented measuring roll having a plurality of measuring segments,
the measuring segments are arranged on the axle in a respective measuring position such that the spaced apart longitudinal strips of the running material web wrap around in each case one or more measuring segments, and each measuring segment is wrapped around by at most one longitudinal strip,
each measuring segment includes a dedicated load cell for determining a web tension fraction of the longitudinal strip wrapped around the measuring segment, the load cell providing a mount with which the measuring segment sits on the axle,
the force measuring device further comprises an evaluation unit to which the measuring segments are connected via electrical conductors and to which the measuring signals supplied by the load cells of the measuring segments are conductible, and
the evaluation unit comprises a web tension aggregation means that is arranged and adapted to determine, for each longitudinal strip, from the web tension fractions that are determined by the load cells of the measuring segments wrapped around by said longitudinal strip, the total web tension of the longitudinal strip.

Here, the measuring segments expediently comprise, in addition to the load cell, a roll shell and, supported by the load cell, a bearing for the roll shell.

In one preferred embodiment, the load cell includes in each case, supported on the axle, an inner ring that provides the said mount. The load cell further comprises a concentric outer ring that is displaceable with respect to the inner ring under the application of force, and a measuring section that connects the inner ring and outer ring in a connecting region. When measuring the web tension, as a result of the application of force, the outer ring is displaced radially relative to the inner ring, and in this way, in the measuring section, tensions are produced that can be measured by means of strain gauges. In one advantageous embodiment, the measuring section is formed in the form of a double-bending beam.

The inner ring particularly advantageously comprises an indentation in which the connecting region with the outer ring is accommodated. The indentation can extend radially up to half the radius of the inner ring, preferably even to the midpoint of the inner ring. The load cell is advantageously guided in an axial guide chamber of the axle with the indentation of the inner ring. In this way, a particularly compact design of the load cell and the force measuring device is achieved and, furthermore, the load cell integrated with the axle of the force measuring device.

According to one advantageous variant of the present invention, the inner ring and the outer ring are arranged radially nested and connected in a radial connecting region by the measuring section. As overload protection, the inner ring and the outer ring are preferably separated outside the connecting region by a narrow radial gap whose width is dimensioned in such a way that, in the event of overload, the movable outer ring rests against the inner ring that is fixed on the axle. The gap width corresponds, for example, to 110% of the measuring path at nominal load and is typically in the range of a few tenths of a millimeter.

In another, likewise advantageous embodiment, the inner ring and the outer ring are arranged spaced apart axially and connected in an axial connecting region by the measuring section.

The load cell is advantageously furnished with strain gauges for measuring the web tension. The measuring section that connects an inner ring and outer ring is preferably furnished with the said strain gauges for measuring the mechanical tension produced in the measuring section.

The inner ring, the outer ring and the measuring section of the load cell are particularly advantageously formed to be one piece.

According to one preferred embodiment, the axle is formed as an extruded profile. The extruded profile preferably comprises a vertical web and two horizontal guide rails going out from the vertical web, such that the vertical web and the two guide rails form an axial guide chamber, especially a U-shaped axial guide chamber, in the extruded profile of the axle.

Alternatively, the axle can also be formed as a milled axle in which the axial guide chamber and, if applicable, further recesses, such as an axial groove for an air tube and a pressure strip, are milled into a round bar.

In one advantageous embodiment, the electrical conductors are provided in the axle and extending substantially in the axial direction across the entire width of the axle and are contactable axially at every position. The axle particularly preferably comprises an axial guide chamber that is furnished with axially running power rails that are contactable at an arbitrary axial position by current collectors in the load cells of the measuring segments and form the said electrical conductors. Particularly advantageously, in the axial guide chamber, both the load cell is guided with the indentation of the inner ring, and the axially running power rails are arranged.

However, the electrical connection between the measuring segments and the evaluation unit need not necessarily occur via the axle. There can, for example, also be electrical conductors provided, in each case between adjacent measuring segments, and only the outermost measuring segment (or the outermost measuring segments) be connected directly to the evaluation unit, such that the measuring signals are looped through to the evaluation unit via the conductors that connect the measuring segments. Here, it is understood that also the inner measuring segments are electrically connected to the evaluation unit, but only the outermost measuring segment, or the outermost measuring segments in each case on both sides of the axle, have a direct connection, that is, a connection that does not run via another measuring segment.

The measuring segments preferably include in each case an electronics unit for feeding the strain gauges and for receiving, for preamplifying, preferably additionally for digitalizing, and for passing the preamplified and, if applicable, digitalized measuring signals into the electrical lines, especially the power rails of the axle. Digitalizing the measuring signals is advantageous especially when the segmented measuring roll comprises a larger number of measuring segments, for example four or more or six or more measuring segments, since the digitalized measuring signals can then be routed to the evaluation unit over few, typically two, current lines using a bus protocol. Especially when the segmented measuring roll includes only a small number of measuring segments, the measuring signals can, of course, also be conducted to the evaluation unit in analog form, in each case via a dedicated current line.

For measuring the rotation speed, each measuring segment is advantageously furnished with a device for measuring the rotation speed, the device preferably comprising one or more magnets that revolve with the roll shell and comprise a static Hall sensor that is connected to the load cell. From the Hall voltage produced when revolving, the rotation speed of each measuring segment can be calculated in the manner known to the person of skill in the art and routed to the evaluation unit via the electronics unit. The individual determination of the rotation speed of each measuring segment especially allows it to be established whether slip occurs in one or more measuring segments during operation, for example due to dirty or damaged roller bearings.

In one advantageous embodiment, the axle includes, in an axial groove, an air tube and a pressure strip for locking the measuring segments on the axle. Here, the evaluation unit preferably includes a pressure sensor for monitoring the air pressure of the air tube. In the event of a deviation of the air pressure from the target value, the evaluation unit can, for example, emit a warning signal or initiate other suitable measures.

Alternatively, the measuring segments can also be mechanically fixed on the axle, it also being possible to consider an individual fixation of each individual segment, for example with the aid of a setscrew.

On the axle are advantageously arranged three or more, especially six or more, or even ten or more measuring segments in a respective measuring position.

In one advantageous embodiment, the measuring segments are arranged on the axle in such a way that their roll shells are adjacent practically without gaps without touching each other. The roll shells of the measuring segments advantageously comprise the same width.

The present invention also includes a system for measuring the web tensions of a plurality of longitudinal strips of a longitudinally cut running material web that comprises a longitudinal direction defined by the running direction of the material web and a transverse direction, having
two or more different material paths for guiding, in each case, one portion of the longitudinal strips of the cut material web in different planes to obtain multiple material subwebs having, in each case, a plurality of spaced apart longitudinal strips, and
two or more force measuring devices of the kind described above for measuring the web tensions of the plurality of spaced apart longitudinal strips of the material subwebs.

Here, in one preferred embodiment, exactly two material paths are provided for guiding alternating longitudinal strips of the cut material web in two different planes to obtain two material subwebs having, in each case, a plurality of spaced apart longitudinal strips, and there are provided two force measuring devices of the kind described above for measuring the web tensions of the plurality of spaced apart longitudinal strips of the material subwebs.

The present invention further includes a method for measuring the web tensions of a plurality of spaced apart longitudinal strips of a longitudinally cut running material web with a force measuring device of the kind described above, in which
the plurality of spaced apart longitudinal strips of the material web are guided over the segmented measuring roll of the force measuring device in such a way that the spaced apart longitudinal strips wrap around in each case one or more measuring segments, and each measuring segment is wrapped around by at most one longitudinal strip,
the web tension fraction of the longitudinal strip wrapping around the respective measuring segment is determined with the load cells of the measuring segments,
the measuring signals determined by the load cells are routed to the evaluation unit, and the total web tension of the longitudinal strip is determined for each longitudinal strip by the web tension aggregation means from the web tension fractions that were determined by the load cells of the measuring segments wrapped around by said longitudinal strip.

Finally, the present invention also includes a method for measuring the web tensions of a plurality of longitudinal strips of a longitudinally cut running material web with a system of the kind described above, in which
in each case, a portion of the longitudinal strips of the cut material web are guided along one of the material paths in different planes, such that multiple material subwebs are obtained, having in each case a plurality of spaced apart longitudinal strips, and
the web tensions of the plurality of spaced apart longitudinal strips of the material subwebs are measured with two or more force measuring devices of the kind described above.

Measuring the web tensions of the longitudinal strips of a cut web is what makes it even possible to individually control the winding process and thus avoid a lot of waste resulting from unsuitable tension conditions in individual longitudinal strips.

In a further aspect, the present invention relates to the problem of determining the tension profile of an uncut running material web that comprises a longitudinal direction defined by the running direction of the material web and a transverse direction. To solve this object, a force measuring device is provided that comprises an axle and, supported on the axle, a measuring roll wrapped around by the material web, in which
the measuring roll is formed as a segmented measuring roll having a plurality of measuring segments,
the measuring segments are arranged on the axle in a respective measuring position,
each measuring segment includes a dedicated load cell for determining a web tension fraction of the longitudinal section of the material web wrapped around the measuring segment, the load cell providing a mount with which the measuring segment sits on the axle,
the force measuring device further comprises an evaluation unit to which the measuring segments are connected via electrical conductors and to which the measuring signals supplied by the load cells of the measuring segments are conductible,
electrical conductors being provided in each case between adjacent measuring segments and only the outermost measuring segment or the outermost measuring segments being connected directly to the evaluation unit, such that the measuring signals are looped through to the evaluation unit via the conductors that connect the measuring segments.

Here, too, it is understood that also the inner measuring segments are electrically connected to the evaluation unit, but that only the outermost measuring segment or the in each case outermost measuring segments on both sides of the axle have a direct connection, that is, a connection that does not run via another measuring segment.

In one advantageous embodiment, the measuring segments comprise, in addition to the load cell, a roll shell and, supported by the load cell, a bearing for the roll shell, and the measuring segments are arranged on the axle in such a way that their roll shells are adjacent practically without gaps without touching each other.

Further details and advantages of the force measuring device of the further aspect correspond to the details and advantages of the force measuring device already described in detail above, with a few particularly advantageous embodiments being briefly mentioned below:

Also in the case of the force measuring device of the further aspect, the load cell advantageously comprises in each case, supported on the axle, an inner ring that provides the said mount. The load cell further comprises a concentric outer ring that is displaceable with respect to the inner ring under the application of force, and a measuring section that connects the inner ring and outer ring in a connecting region. When measuring the web tension, as a result of the application of force, the outer ring is displaced radially relative to the inner ring, and in this way, in the measuring section, tensions are produced that can be measured by means of strain gauges. In one advantageous embodiment, the measuring section is formed in the form of a double-bending beam.

The inner ring particularly advantageously comprises an indentation in which the connecting region with the outer ring is accommodated. The indentation can extend radially up to half the radius of the inner ring, preferably even to the midpoint of the inner ring. The load cell is advantageously guided in an axial guide chamber of the axle with the indentation of the inner ring. In this way, a particularly compact design of the load cell and the force measuring device is achieved and, furthermore, the load cell integrated with the axle of the force measuring device.

According to one advantageous variant of the present invention, the inner ring and the outer ring are arranged radially nested and connected in a radial connecting region by the measuring section. As overload protection, the inner ring and the outer ring are preferably separated outside the connecting region by a narrow radial gap whose width is dimensioned in such a way that, in the event of overload, the movable outer ring rests against the inner ring that is fixed on the axle. The gap width corresponds, for example, to 110% of the measuring path at nominal load and is typically in the range of a few tenths of a millimeter.

In another, likewise advantageous embodiment, the inner ring and the outer ring are arranged spaced apart axially and connected in an axial connecting region by the measuring section.

The load cell is advantageously furnished with strain gauges for measuring the web tension. The measuring section that connects an inner ring and outer ring is preferably furnished with the said strain gauges for measuring the mechanical tension produced in the measuring section.

The inner ring, the outer ring and the measuring section of the load cell are particularly advantageously formed to be one piece.

According to one preferred embodiment, the axle is formed as an extruded profile. The extruded profile preferably comprises a vertical web and two horizontal guide rails going out from the vertical web, such that the vertical web and the two guide rails form an axial guide chamber, especially a U-shaped axial guide chamber, in the extruded profile of the axle.

Alternatively, the axle can also be formed as a milled axle in which the axial guide chamber and, if applicable, further recesses, such as an axial groove for an air tube and a pressure strip, are milled into a round bar.

The measuring segments preferably include in each case an electronics unit for feeding the strain gauges and for receiving, for preamplifying, preferably additionally for digitalizing, and for passing the preamplified and, if applicable, digitalized measuring signals into the electrical lines, especially the power rails of the axle. Digitalizing the measuring signals is advantageous especially when the segmented measuring roll comprises a larger number of measuring segments, for example four or more or six or more measuring segments, since the digitalized measuring signals can then be routed to the evaluation unit over few, typically two, current lines using a bus protocol. Especially when the segmented measuring roll includes only a small number of measuring segments, the measuring signals can, of course, also be conducted to the evaluation unit in analog form, in each case via a dedicated current line.

For measuring the rotation speed, each measuring segment is advantageously furnished with a device for measuring the rotation speed, the device preferably comprising one or more magnets that revolve with the roll shell and comprise a static Hall sensor that is connected to the load cell. From the Hall voltage produced when revolving, the rotation speed of each measuring segment can be calculated in the manner known to the person of skill in the art and routed to the evaluation unit via the electronics unit. The individual determination of the rotation speed of each measuring segment especially allows it to be established whether slip occurs in one or more measuring segments during operation, for example due to dirty or damaged roller bearings.

In one advantageous embodiment, the axle includes, in an axial groove, an air tube and a pressure strip for locking the measuring segments on the axle. Here, the evaluation unit preferably includes a pressure sensor for monitoring the air pressure of the air tube. In the event of a deviation of the air pressure from the target value, the evaluation unit can, for example, emit a warning signal or initiate other suitable measures.

Alternatively, the measuring segments can also be mechanically fixed on the axle, it also being possible to consider an individual fixation of each individual segment, for example with the aid of a setscrew.

Finally, in the force measuring device of the further aspect, on the axle are advantageously arranged next to one another practically without gaps three or more, especially six or more, or even ten or more measuring segments. The roll shells of the measuring segments advantageously comprise the same width.

Further exemplary embodiments and advantages of the present invention are explained below with reference to the drawings, in which a depiction to scale and proportion was dispensed with in order to improve their clarity.

Shown are:

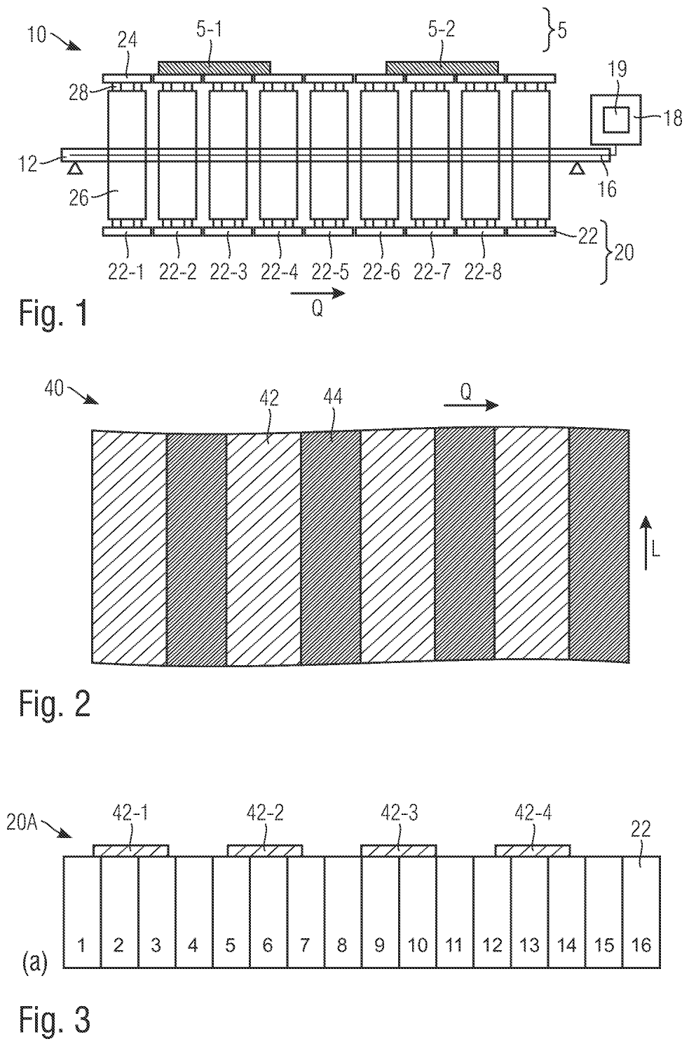

FIG. 1 schematically, a force measuring device according to the present invention,

FIG. 2 a cut material web having longitudinal strips whose web tensions are to be measured,

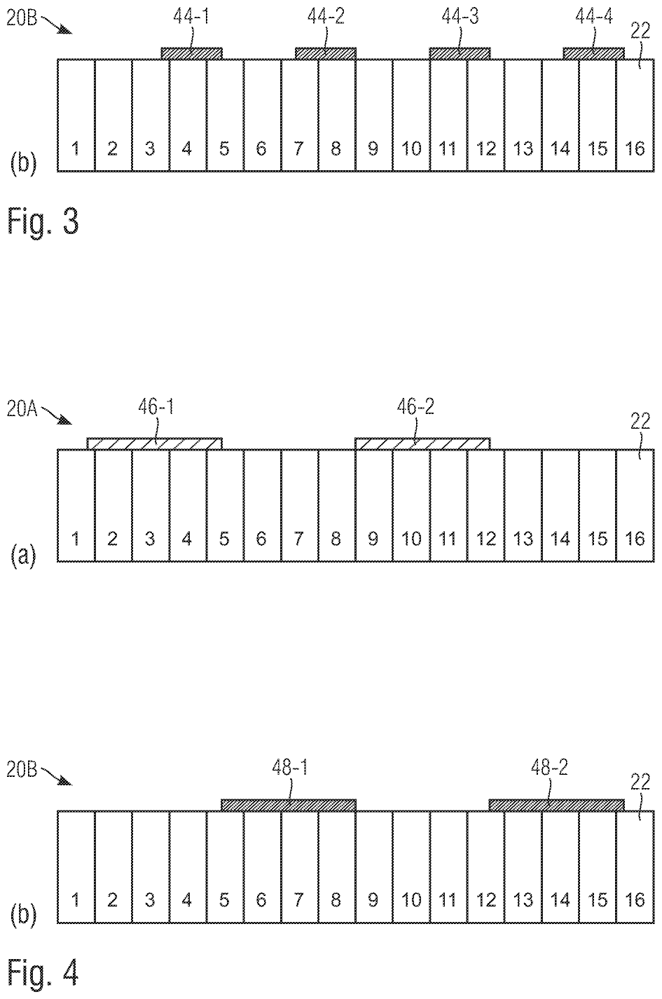

FIG. 3 in (a) and (b), in each case, the measuring roll of a force measuring device according to the present invention whose measuring segments are wrapped around by alternating longitudinal strips of the material web in FIG. 2,

FIG. 4 in (a) and (b), in a diagram as in FIG. 3, the measuring of the web tensions of another cut material web,

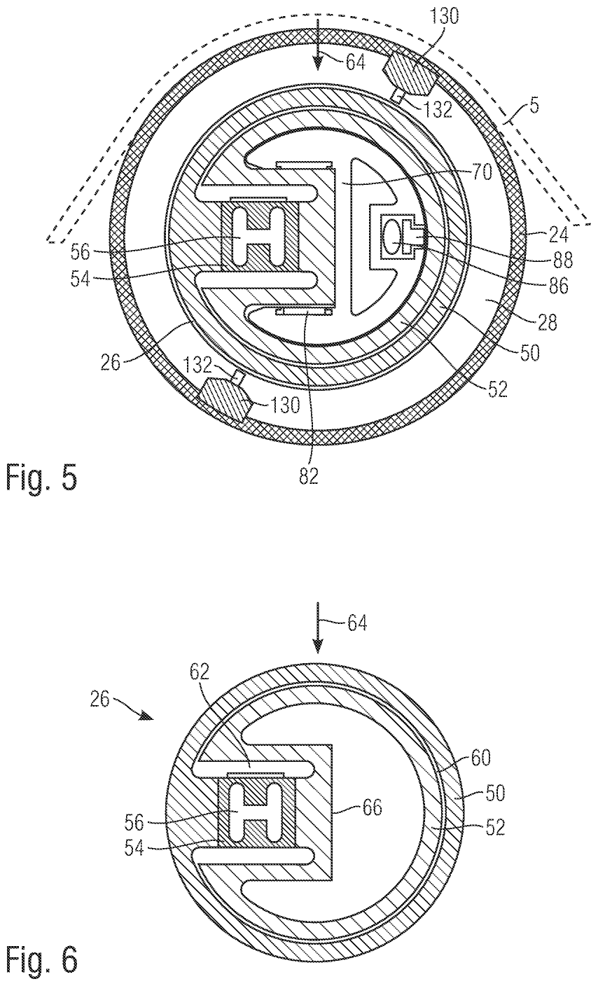

FIG. 5 a cross section through a force measuring device according to the present invention,

FIG. 6 the load cell of a measuring segment of the force measuring device in

FIG. 5 separately in cross section,

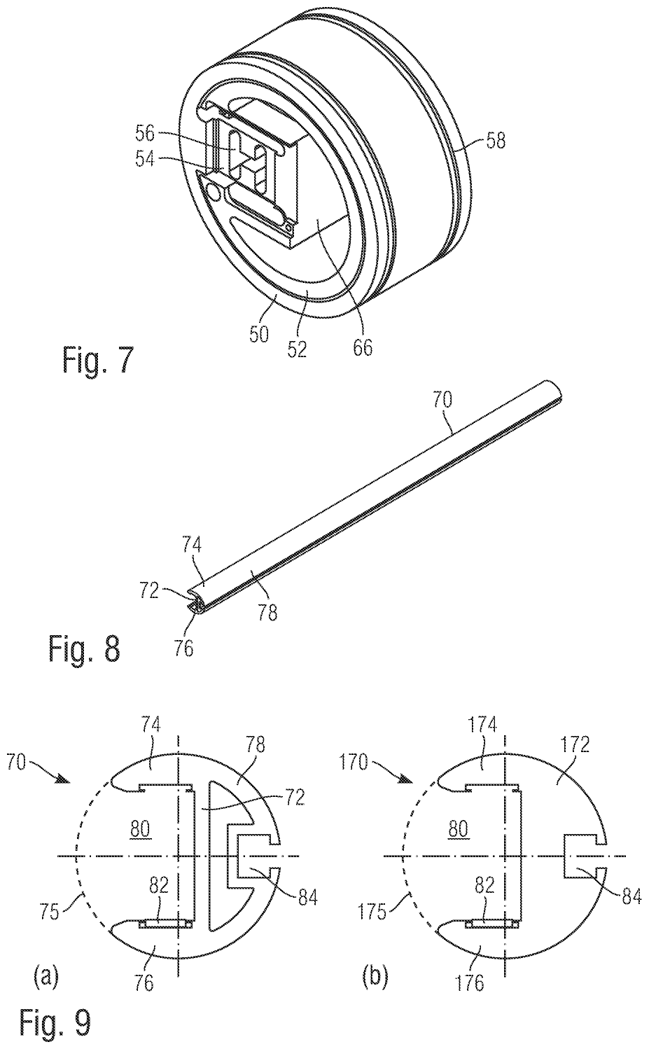

FIG. 7 a perspective view of the load cell in FIG. 6,

FIG. 8 the axle of the force measuring device in FIG. 5 separately in perspective view,

FIG. 9 in (a), the axle in FIG. 8 in cross section, in (b), a milled axle according to a further exemplary embodiment of the present invention,

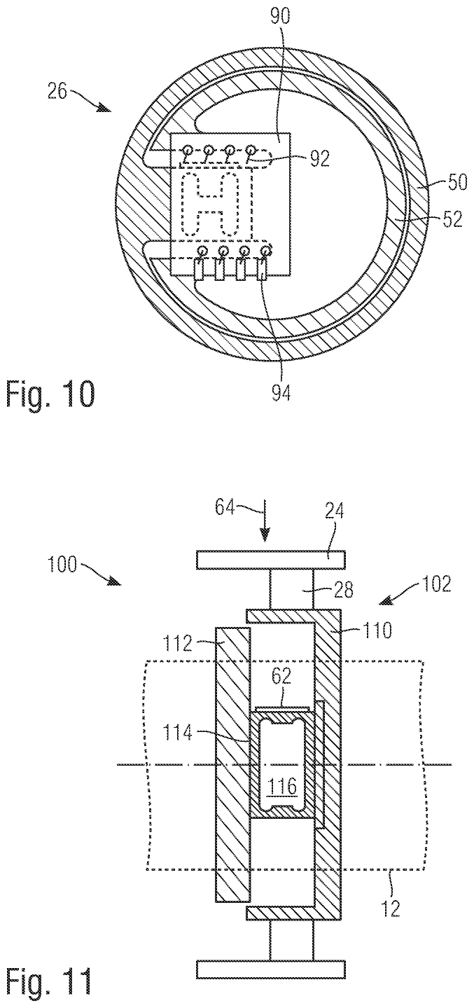

FIG. 10 the load cell in FIG. 6 with an electronics board and the contact regions to the strain gauges and the power rails of the axle drawn in,

FIG. 11 a load cell according to the present invention having a measuring section that runs in the axial direction, in cross section,

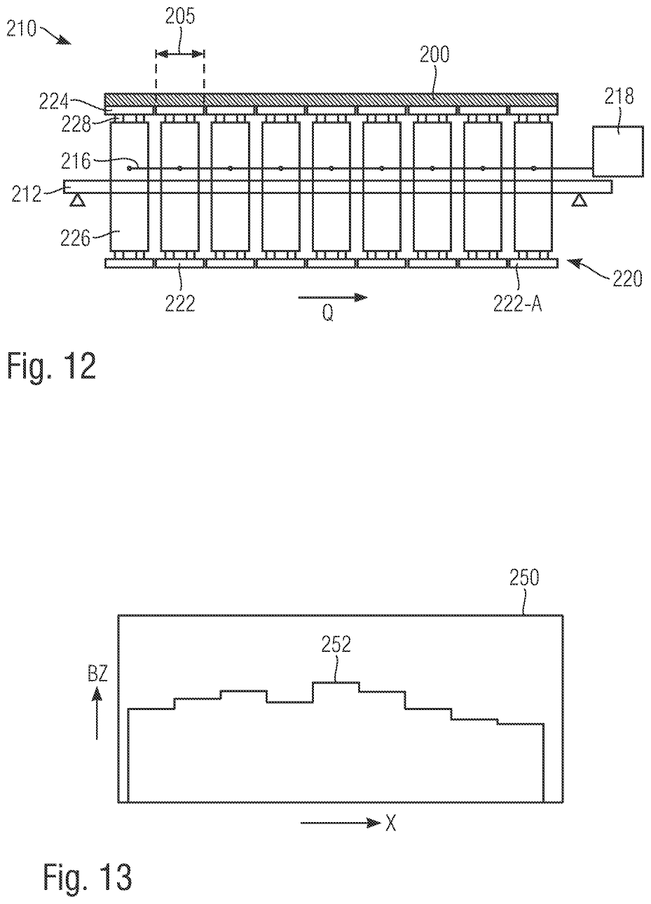

FIG. 12 a force measuring device for measuring the tension profile of an uncut running material web, and

FIG. 13 schematically, a tension profile of an uncut material web measured with the force measuring device in FIG. 12, in which the web tension BZ is plotted over the dimension x in the transverse direction.

The present invention will now be explained in greater detail using the example of force measuring devices for measuring the web tensions of a plurality of longitudinal strips of a cut running material web.

For this, FIG. 1 shows, schematically, a force measuring device 10 having a rigid axle 12 that, at its two ends, rests on a structural subframe, not depicted. Supported on the axle 12 is a segmented measuring roll 20 that, in measuring mode, is wrapped around by the spaced apart longitudinal strips 5 of the running material web to be measured.

The measuring roll 20 includes a plurality of measuring segments 22 that are arranged next to one another practically without gaps on the axle 12 in a respective measuring position along the transverse direction Q. Each measuring segment 22 comprises a roll shell 24 that, in measuring mode, can be wrapped around by one of the longitudinal strips 5 across its full width or also only across a part of its width. The roll shell 24 is, in each case, connected via one or more roller bearings 28 to a load cell 26 that serves to determine a web tension fraction for the wrapping longitudinal strip 5. Moreover, every load cell 26 provides a mount with which the respective measuring segment 22 sits on the axle 12.

As illustrated in FIG. 1, the longitudinal strips 5 of the running material web wrap around, in each case, several of the measuring segments 22, with, depending on the width and position of the strips 5-1, 5-2, some measuring segments 22 being wrapped around across their entire width and other measuring segments only across a portion of their width. Specifically, in the design in FIG. 1, the longitudinal strip 5-1 wraps around the measuring segment 22-3 across the entire width and around the measuring segments 22-2 and 22-4 across a portion of the width, while the longitudinal strip 5-2 wraps around the measuring segment 22-7 across the entire width and around the measuring segments 22-6 and 22-8 across a portion of the width.

What is essential here is especially that each measuring segment 22 is wrapped around by at most one longitudinal strip 5. As a result, in the evaluation unit 18, the web tension fraction measured by the load cell 26 of the measuring segment 22 can be unambiguously assigned to a certain one of the longitudinal strips 5 by the web tension aggregation means 19. The total web tension of a longitudinal strip 5 then arises from the sum of the web tension fractions that are measured by the load cells 26 of the measuring segments 22 wrapped around by said longitudinal strip.

For example, in the situation in FIG. 1, the web tension of the longitudinal strip 5-1 is the sum of the web tension fractions determined by the load cells of the measuring segments 22-2, 22-3 and 22-4. Accordingly, the web tension of the longitudinal strip 5-2 is the sum of the web tension fractions determined by the load cells of the measuring segments 22-6, 22-7 and 22-8.

For easily and reliably determining the web tensions of the longitudinal strips 5, the axle 12 is formed, in the exemplary embodiment in FIG. 1, as a smart axle that is furnished with electrical conductors 16 that extend in the axial direction substantially across the entire width and that are contactable at every position axially. In measuring mode, with the contacted conductors 16, the measuring signals supplied by the load cells 26 of the measuring segments 22 are routed to the evaluation unit 18 arranged at the axle end with the web tension aggregation means 19. The electrical connection between the measuring segments and the evaluation unit can generally also be made in another way. For example, the electrical conductors 16 can also be arranged on the outside of the axle 12, for instance in an axial groove, or there can be provided between adjacent measuring segments, in each case, electrical conductors with which the measuring signals are looped through to the evaluation unit.

FIGS. 2 to 4 explain in greater detail the approach in calculating the total web tension for the longitudinal strips of a cut material web with the aid of force measuring devices according to the present invention or with the aid of a system according to the present invention.

First, FIG. 2 shows, by way of example, a cut material web 40 whose running direction defines a longitudinal direction L and a transverse direction Q perpendicular thereto. The material web 40 is alternatingly cut into longitudinal strips 42 of a width of 100 mm and longitudinal strips 44 of a width of 80 mm. The cut longitudinal strips 42, 44 are guided, for measuring the web tension and a subsequent winding, alternatingly upward or downward in different planes, such that the longitudinal strips 42, 44 lying next to one another in the transverse direction Q in FIG. 2 do not impede each other during web tension measuring and winding.

The web tensions of the longitudinal strips 42 are determined with a first inventive force measuring device having a measuring roll 20A, which is depicted in FIG. 3(a), and the web tensions of the longitudinal strips 44 are determined with a second inventive force measuring device having a measuring roll 20B, which is depicted in FIG. 3(b). Each measuring roll 20A, 20B includes, in the exemplary embodiment 16, measuring segments 22 of the kind described above that are arranged next to one another and have, in each case, a width of, for example, 50 mm. For easy reference, the measuring segments are numbered consecutively from left to right.

As shown in FIGS. 3(a) and (b), the longitudinal strips 42, 44 wrap around, in each case, two or more of the measuring segments 22 of the measuring rolls 20A, 20B across the entire width or a portion of the width of the measuring segments. Here, each measuring segment 22 is wrapped around by at most one longitudinal strip 42, 44, such that an unambiguous assignment of the measured web tension fractions to the strips is possible.

Specifically, in the exemplary embodiment shown, the longitudinal strip 42-1 wraps around the measuring segments #1, #2 and #3 of the measuring roll 20A, and that across the entire width of the measuring segment #2 and across a portion of the width of the measuring segments #1 and #3. The longitudinal strip 42-2 wraps around the measuring segment #6 across the entire width and the measuring segments #5 and #7 across a portion of the width, the longitudinal strip 42-3 wraps around the measuring segments #9 and #10 across the entire width and the longitudinal strip 42-4 wraps around the measuring segment #13 across the entire width and the measuring segments #12 and #14 across a portion of the width.

Table I shows, for the 16 measuring segments of the measuring roll 20A, the web tension fractions measured in each case by the load cells, in newtons (N). From said web tension fractions and the assignment of the longitudinal strips 42-1 to 42-4 to the measuring segments, the total web tension of the respective longitudinal strip in Newtons (N) can be determined by adding up the web tension fractions. As a simple calculation example, a web tension of 100 N per 100 mm web width was chosen. For a correct determination of the web tensions, it is important that each measuring segment 22 is wrapped around by at most one longitudinal strip, since only then is an unambiguous assignment of a measured web tension fraction to one of the longitudinal strips possible. From FIG. 3(a) and Table I, it is also evident that some measuring segments are normally not wrapped around by a longitudinal strip. Accordingly, the measured web tension in said measuring segments is zero and does not contribute to the total web tension of one of the longitudinal strips.

TABLE I

| Measuring | Measured | | Total web |
|---|---|---|---|
| segment roll | web tension | Strip | tension |
| 20A | fraction (N) | assignment | (N) |
| #1 | 10 | 42-1 | 100 |
| #2 | 50 | 42-1 | |
| #3 | 40 | 42-1 | |
| #4 | 0 | | |
| #5 | 30 | 42-2 | 100 |
| #6 | 50 | 42-2 | |
| #7 | 20 | 42-2 | |
| #8 | 0 | | |
| #9 | 50 | 42-3 | 100 |
| #10 | 50 | 42-3 | |
| #11 | 0 | | |
| #12 | 20 | 42-4 | 100 |
| #13 | 50 | 42-4 | |
| #14 | 30 | 42-4 | |
| #15 | 0 | | |
| #16 | 0 | | |

For determining the total web tensions of the longitudinal strips 42, 44, prior to measuring, there is stored in the evaluation unit 18 assigned to the measuring roll 20A, or in the associated web tension aggregation means 19, which of the measuring segments 22 are assigned in each case to the longitudinal strips 42-1 to 42-4, that is, are wrapped around by said longitudinal strips in measuring mode. When measuring, the web tension fractions calculated by the load cells 26 of the measuring segments are routed to the evaluation unit 18 via the electrical conductors 16 of the axle 12. The web tension aggregation means 19 then determines from the calculated web tension fractions and the stored strip assignments the total web tension for each of the longitudinal strips 42-1 to 42-4.

For example, the measuring segments #1, #2 and #3 of the measuring roll 20A are assigned to the longitudinal strip 42-1 and the web tension fractions of said measuring segments transmitted to the evaluation unit are 10 N (segment #1), 50 N (segment #2) and 40 N (segment #3). The total web tension of the longitudinal strip 42-1 is thus 10 N+50 N+40 N=100 N.

With reference to FIG. 3(b), in the second plane, the longitudinal strip 44-1 wraps around the measuring segments #3, #4 and #5 of the measuring roll 20B, the longitudinal strip 44-2 the measuring segments #7 and #8, the longitudinal strip 44-3 the measuring segments #11 and #12, and the longitudinal strip 44-4 the measuring segments #14, #15 and #16.

Table II shows, for the 16 measuring segments 22 of the measuring roll 20B, the web tension fractions measured in each case by the load cells, in newtons (N), the strip assignment, and the total web tensions of the longitudinal strips 44 determined therefrom, in newtons (N). Here, the approach follows the approach already described above with reference to the measuring roll 20A.

TABLE II

| Measuring | Measured | | Total web |
|---|---|---|---|
| segment roll | web tension | Strip | tension |
| 20B | fraction (N) | assignment | (N) |
| #1 | 0 | | |
| #2 | 0 | | |
| #3 | 10 | 44-1 | 80 |
| #4 | 50 | 44-1 | |
| #5 | 20 | 44-1 | |
| #6 | 0 | | |
| #7 | 30 | 44-2 | 80 |
| #8 | 50 | 44-2 | |
| #9 | 0 | | |
| #10 | 0 | | |
| #11 | 50 | 44-3 | 80 |
| #12 | 30 | 44-3 | |
| #13 | 0 | | |
| #14 | 20 | 44-4 | 80 |
| #15 | 50 | 44-4 | |
| #16 | 10 | 44-4 | |

The measurement of the web tensions of another cut material web having longitudinal strips 46, 48 of a constant width is illustrated in FIG. 4. The longitudinal strips 46, 48 comprise in each case a width of 180 mm and are guided, like the longitudinal strips in FIG. 3, alternatingly upward or downward in different planes so as not to impede each other during web tension measuring and a subsequent winding.

With reference to FIG. 4(a), in a first plane, the longitudinal strip 46-1 wraps around the measuring segments #1 to #5 of the measuring roll 20A, and the longitudinal strip 46-2, the measuring segments #9 to #12. Table III shows, for the 16 measuring segments 22 of the measuring roll 20A, the web tension fractions measured in each case by the load cells, in newtons (N), the strip assignment, and the total web tensions of the longitudinal strips 46 determined therefrom, in newtons (N).

TABLE III

| Measuring | Measured | | Total web |
|---|---|---|---|
| segment roll | web tension | Strip | tension |
| 20A | fraction (N) | assignment | (N) |
| #1 | 10 | 46-1 | 180 |
| #2 | 50 | 46-1 | |
| #3 | 50 | 46-1 | |
| #4 | 50 | 46-1 | |
| #5 | 20 | 46-1 | |
| #6 | 0 | | |
| #7 | 0 | | |
| #8 | 0 | | |
| #9 | 50 | 46-2 | 180 |
| #10 | 50 | 46-2 | |
| #11 | 50 | 46-2 | |
| #12 | 30 | 46-2 | |
| #13 | 0 | | |
| #14 | 0 | | |
| #15 | 0 | | |
| #16 | 0 | | |

With reference to FIG. 4(b), in a second plane, the longitudinal strip 48-1 wraps around the measuring segments #5 to #8 of the measuring roll 20B, and the longitudinal strip 48-2, the measuring segments #12 to #16. Table IV shows, for the 16 measuring segments 22 of the measuring roll 20B, the web tension fractions measured in each case by the load cells, in newtons (N), the strip assignment, and the total web tensions of the longitudinal strips 48 determined therefrom, in newtons (N).

TABLE IV

| Measuring | Measured | | Total web |
|---|---|---|---|
| segment roll | web tension | Strip | tension |
| 20B | fraction (N) | assignment | (N) |
| #1 | 0 | | |
| #2 | 0 | | |
| #3 | 0 | | |
| #4 | 0 | | |
| #5 | 30 | 48-1 | 180 |
| #6 | 50 | 48-1 | |
| #7 | 50 | 48-1 | |
| #8 | 50 | 48-1 | |
| #9 | 0 | | |
| #10 | 0 | | |
| #11 | 0 | | |
| #12 | 20 | 48-2 | 180 |
| #13 | 50 | 48-2 | |
| #14 | 50 | 48-2 | |
| #15 | 50 | 48-2 | |
| #16 | 10 | 48-2 | |

One advantageous embodiment of the measuring segments 22 and the axle 70 of a force measuring device according to the present invention will now be described in greater detail with reference to FIGS. 5 to 10. Here, FIG. 5 shows a cross section through the force measuring device 10 and one of the measuring segments 22. The load cell 26 of a measuring segment 22 alone is depicted in FIG. 6 in cross section, in FIG. 7 in perspective view, and in FIG. 10 having an electronics board drawn in, the axle 70 alone is shown in perspective view in FIG. 8 and in cross section in FIG. 9.

With reference first to FIG. 5, a measuring segment 22 includes, radially from outside to inside, a roll shell 24, a roller bearing 28 and a load cell 26. A longitudinal strip 5 wrapping around the measuring segment 22 is indicated with dashed lines.

The load cell 26 depicted again separately in FIGS. 6 and 7 comprises an outer ring 50, a concentric inner ring 52 and a measuring section 54 having an

H-shaped recess 56. The outer ring 50 can comprise indentations 58 (FIG. 7) for receiving the roller bearing 28 using retaining rings, not depicted, the inner ring 52 is supported on the axle 70 and provides the above-mentioned mount. In the exemplary embodiment, the inner ring 52 and the outer ring 50 are arranged radially nested and connected in a radial connecting region by the measuring section 54. For this, the inner ring 52 comprises an indentation 66 that extends radially to the midpoint of the inner ring 52. On one hand, the connecting region with the outer ring is accommodated in the indentation 66, and on the other hand, said indentation serves to securely guide the load cell in the axial guide chamber 80 (FIG. 9) of the axle 70.

The outer ring 50, the inner ring 52 and the measuring section 54 are formed to be one piece, the different hatchings in FIGS. 5 and 6 serve merely to illustrate the different functional regions 50, 52, 54 of the load cell 26.

Outside of the connecting region, the inner and the outer ring are separated by a radial gap 60 whose width is dimensioned in such a way that, in the event of overload, the movable outer ring 50 rests against the inner ring 52 that is fixed on the axle 70 and, in this way, avoids plastic deformation and thus destruction of the load cell 26. In the exemplary embodiment, the width of the gap 60 is designed to be 110% of the measuring path at nominal load.

Due to the H-shaped recess 56, the measuring section 54 forms a double-bending beam in which, in the exemplary embodiment shown, strain gauges 62 for measuring, at the material surface, the mechanical tension produced by the application of force are arranged on its top side. It is understood that strain gauges 62 can also be provided on the underside or on both the top and bottom side or within the double-bending beam.

The wrapping around of the measuring segment 22 with a longitudinal strip 5 of the material web produces a force 64 that depends on the wrap angle and the web tension fraction, that displaces the movable outer ring 50 of the load cell 26 downward with respect to the fixed inner ring 52 and, in this way, causes a bending of the double-bending beam of the measuring section 54. Said bending is measured by the strain gauges 62 and a corresponding electrical signal is produced that is preamplified by an electronics unit of the measuring segment 22 and transmitted in suitable form via the power rails of the axle 70 to the evaluation unit 18. Due to the high sensitivity and resolution of said measuring principle, also the forces of longitudinal strips that wrap around a measuring segment across only a small portion of its width are measured correctly.

With reference to FIGS. 5, 8 and 9(a), in the exemplary embodiment shown, the axle 70 is formed as an extruded profile that, across its width, can accommodate a plurality of individually measuring measuring segments 22. The formation of the axle 70 as an extruded profile enables a rigid formation of the axle, which also does not deform, or deforms only minimally, at maximum stress due to high web tensions, and thus does not influence the geometric arrangement of the measuring segments across the width, and therefore also does not influence the web tension measurement.

In the exemplary embodiment, the extruded profile axle 70 is formed having a circular cross-sectional perimeter 75. It includes a central vertical web 72 that ensures the stability of the axle and from which two horizontal guide rails 74,76 and a guide curve 78 go out. The horizontal guide rails 74,76, together with the web 72, form, in the axle 70, a U-shaped, axial guide chamber 80 that is open on one side and into which the indentation 66 of the inner ring extends for guiding and for electrically connecting the load cell (FIG. 5). With their curvature, the guide curve 78 and the radial outer faces of the guide rails 74, 76 are adapted with a tight tolerance to the curvature of the inner ring 52 such that the measuring segments 22 can be easily and securely mounted on the axle.

To route the electrical signals produced by the strain gauges 62 of the load cell of a measuring segment 22 to the evaluation unit 18, the lower horizontal guide rail 76 of the axle 70 is furnished in a recessed region with axially running power rails 82 that enable the power supply and the electrical contact to the measuring segments 22 independently of their measuring position on the axle 70. It is understood that the power rails can generally also be provided in another location in the guide chamber, for example on the upper guide rail 74 or also on both guide rails 74, 76.

Instead of an extruded profile, the axle can also be formed as a milled axle 170, as depicted in FIG. 9(b), into which a, for example U-shaped, axial guide chamber 80 and an axial groove are milled. Here, the axle body 172 includes a central vertical supporting structure that ensures the stability of the axle and from which two horizontal guide rails 174, 176 go out to form, in the axle 70, together with the axle body 172 within the cross-sectional perimeter 175, an axial guide chamber 80 into which the indentation 66 of the inner ring protrudes for guiding and for electrically connecting the load cell.

As illustrated in FIG. 10, the load cells 26 include, in addition to the mechanical elements already described, a board 90 having an electronic circuit that, for feeding and receiving the measuring signal, is connected in a contact region 92 to the strain gauges 62 and that can, via current collectors 94, make contact with the power rails 82 at any arbitrary axial measuring position of the axle 70. In the exemplary embodiment shown, the electronic circuit of the board 90 includes, for preparing the signals, a preamplifier that amplifies and digitalizes the measuring signals of the strain gauges 62 and transmits the digitalized measuring signal to an internal bus.

In the exemplary embodiment shown, the evaluation unit 18 is arranged at an end of the axle. The evaluation unit 18 communicates with the measuring segments 22 on the axle 70, receives their measured values and further processes them with the web tension aggregation means 19. The evaluation unit can also be multipart and can include, for example, two evaluation subunits that are arranged on both sides of the axle and that each receive and further process the measuring signals of a portion of the measuring segments.

In the exemplary embodiment, for the communication with the evaluation unit 18, in addition to two power rails for the power supply, the power rails 82 of the axle include two further power rails for data transfer, for example according to the RS-485 standard. In general, the preamplified measuring signals can, of course, also be routed to the evaluation unit in analog form.

The web tension aggregation means 19 especially includes a means for storing an assignment of longitudinal strips of a material web to be measured and the measuring segments 22 of the segmented measuring roll 20, as well as a means for calculating, from the web tension fractions measured by the measuring segments and the assignment of the measuring segments to the longitudinal strips, the total web tension for each of the longitudinal strips.

For its part, the evaluation unit 18 communicates via a standardized bus protocol with a higher-level controller that, based on the calculated web tensions of the longitudinal strips, triggers suitable actions, for example makes one of the drives run slower or faster, issues an alarm notice, or the like.

The measuring segments 22 can be securely locked on the axle 70, for example, with the aid of an axial air tube 86 and an axial pressure strip 88 (FIG. 5), both of which are inset in a groove 84 formed in the guide curve 78 of the axle 70.

In the slackened state of the air tube 86, the measuring segments 22 can be slid onto the axle and brought into the desired measuring positions on the axle. If the air tube 86 is then inflated, it presses, with a force that is dependent on the air pressure, against the pressure strip 88, which in this way is pushed radially slightly out of the groove 84. In this way, the pressure strip 88 pins the positioned measuring segments 22 against a defined stop on the axle 70 and, in this way, simultaneously locks all measuring segments 22 in their correct measuring position. The air pressure of the air tube 86 is monitored by a pressure sensor arranged in the evaluation unit 18 at the end of the axle.

In another variant of the present invention, instead of the air tube and the pressure strip, it is provided that the measuring segments 22 are furnished in each case with a mechanical locking device through which they can be individually fixed on the axle.

In the described exemplary embodiment in FIGS. 5 to 10, the measuring section 54 runs between the inner and outer rings in the radial direction, which is currently preferred due to the simpler design and high non-positive tension. However, it is likewise possible to have the measuring section of a measuring segment run in the axial direction, as explained below with reference to the exemplary embodiment in FIG. 11, in which a measuring segment 100 of a force measuring device according to the present invention is shown schematically in side view. It is understood that a plurality, for example 16, of such measuring segments 100 are arranged on an axle in the force measuring device.

The measuring segment 100 includes a load cell 102 that comprises an outer ring 110, a concentric inner ring 112 arranged spaced apart axially, and an axial measuring section 114. The inner ring 112 sits with little tolerance on the axle 12, indicated in the figure with dashed lines, such that, in the untensioned state, it can be displaced along the axle. The outer ring 110 carries, externally, the bearing seat for the roller bearings 28, on whose outer perimeter the roll shell 24 is applied.

The outer ring 110 and the inner ring 112 are connected by an axial measuring section 114 that, in the exemplary embodiment, comprises a substantially H-shaped recess 116 and forms a double-bending beam that is furnished with strain gauges 62 for measuring the tensions of the measuring section 114. The tolerance of the outer ring 110 with respect to the axle 12 is dimensioned in such a way that, in the event of overload, the outer ring rises on the axle 12 and, in this way, avoids a destruction of the load cell 102.

If, due to the web tension, a force 64 presses on the roll shell 24 of the measuring segment 100, then the force is transferred via the roller bearings to the outer ring 110, which is supported on the inner ring 112 via the measuring section 114. The tensions produced as a result in the measuring section 114 are measured by the strain gauges 62 and the electrical signals produced, as already generally described above, preamplified, if applicable, digitalized, and passed into the current lines of the axle 12. The measuring segments 100 are fixed on the axle 12 in their measuring position, for example mechanically or pneumatically.

FIG. 12 illustrates the measuring of the tension profile of an uncut running material web 200 with a force measuring device 210 according to a further aspect of the present invention. Here, the material web 200 comprises, defined by the running direction of the material web, a longitudinal direction and a transverse direction Q, the tension profile of the material web being intended to be measured in the transverse direction. The knowledge of said tension profile is often of great benefit. To name just one use, in the manufacture of blown films, by measuring the tension profile of the produced film tube, the cooling profile of the hot melt tube can be readjusted to obtain a uniform tension profile of the film tube.

Returning to the diagram in FIG. 12, the force measuring device 210 comprises a rigid axle 212 that, at its two ends, rests on a structural subframe, not depicted. Supported on the axle 212 is a segmented measuring roll 220 that, in measuring mode, is wrapped around by the uncut material web 200 to be measured, each of the plurality of the measuring segments 222 of the measuring roll 220 being wrapped around in the exemplary embodiment by a corresponding longitudinal section 205 of the material web.

The measuring segments 222 are arranged next to one another on the axle 212 along the transverse direction Q practically without gaps. Each measuring segment 222 comprises a roll shell 224 that, in measuring mode, is wrapped around by a portion of the material web 220, namely a longitudinal section 205. The roll shell 224 is, in each case, connected via one or more roller bearings 228 to a load cell 226 that serves to determine the local web tension of the longitudinal section 205. Moreover, every load cell 226 provides a mount with which the respective measuring segment 222 sits on the axle 212.

The force measuring device 210 further comprises an evaluation unit 218 to which the measuring segments 222 are connected via electrical conductors 216 and to which the measuring signals supplied by the load cells 226 of the measuring segments 222 are conductible. Here, electrical conductors 216 are provided in each case between adjacent measuring segments 222 and only the outermost measuring segment 222-A is connected to the evaluation unit 218, so the measuring signals are looped through to the evaluation unit 218 via the conductors 216 that connect the measuring segments 222.

Since each measuring segment 222 includes a dedicated load cell 226 for determining the local web tension of the longitudinal section 205 of the material web wrapped around the measuring segment 222, a tension profile of the material web can be generated from the measured values of all measuring segments 222, as illustrated in FIG. 13.

Here, each of the measuring segments 222 measures, via a dedicated load cell 226, in each case the local web tension BZ(x) at the location x of the respective measuring segment along the transverse direction Q of the material web. From the entirety of the measured values, the evaluation unit 218 can generate a tension profile diagram 250 as in FIG. 13, in which the local web tension BZ(x) is plotted as the curve 252 across the spatial coordinate x in the transverse direction of the material web 200.

From the knowledge of the tension profile 252, suitable measures can then be derived, for example in the event of a non-uniform profile, control measures can be taken that lead to a more uniform tension profile. If the temporal progression of the local web tension 252 is displayed, for example in a waterfall diagram, then also periodic signals, such as out-of-round unwinding rolls, periodic wrinkling and the like, can be easily recognized.

The width of the measuring segments 222 used for measuring the tension profile can be identical, as in the exemplary embodiment in FIG. 12, but it can also be expedient to use measuring segments 222 of different widths. For example, measuring segments 222 having narrower roll shells than at the edge regions of the material web can be used in the middle region of the material web 200.

1. A force measuring device for measuring the web tensions of a plurality of spaced apart longitudinal strips of a longitudinally cut running material web that comprises a longitudinal direction defined by the running direction of the material web and a transverse direction, the force measuring device comprising an axle and, supported on the axle, a measuring roll wrapped around by the material web, in which
the measuring roll is formed as a segmented measuring roll having a plurality of measuring segments,
the measuring segments are arranged on the axle in a respective measuring position such that the spaced apart longitudinal strips of the running material web wrap around in each case one or more measuring segments, and each measuring segment is wrapped around by at most one longitudinal strip,
each measuring segment includes a dedicated load cell for determining a web tension fraction of the longitudinal strip wrapped around the measuring segment, the load cell providing a mount with which the measuring segment sits on the axle,
the force measuring device further comprises an evaluation unit to which the measuring segments are connected via electrical conductors and to which the measuring signals supplied by the load cells of the measuring segments are conductible, and
the evaluation unit comprises a web tension aggregation means that is arranged and adapted to determine, for each longitudinal strip, from the web tension fractions that are determined by the load cells of the measuring segments wrapped around by said longitudinal strip, the total web tension of the longitudinal strip.

2. The force measuring device according to claim 1, characterized in that the measuring segments comprise, in addition to the load cell, a roll shell and, supported by the load cell, a bearing for the roll shell.

3. The force measuring device according to claim 1, characterized in that the load cell comprises, in each case, an inner ring supported on the axle and providing the said mount, a concentric outer ring that is displaceable with respect to the inner ring and, connecting the inner ring and outer ring in a connecting region, a measuring section that is advantageously formed in the form of a double-bending beam, preferably in that the inner ring comprises an indentation in which the connecting region with the outer ring is accommodated, particularly preferably in that the load cell is guided in an axial guide chamber of the axle with the indentation of the inner ring.

4. The force measuring device according to claim 3, characterized in that the inner ring and the outer ring are arranged radially nested and are connected by the measuring section in a radial connecting region, or in that the inner ring and the outer ring are arranged axially spaced apart and are connected by the measuring section in an axial connecting region.

5. The force measuring device according to claim 1, characterized in that the load cell is furnished with strain gauges for measuring the web tension, the measuring section connecting an inner ring and an outer ring preferably being furnished with the said strain gauges for measuring the mechanical tension produced in the measuring section.

6. The force measuring device according to claim 1, characterized in that the axle is formed as an extruded profile that preferably comprises a vertical web and two horizontal guide rails going out from the vertical web, the vertical web and the two guide rails forming an axial guide chamber, especially a U-shaped axial guide chamber, in the extruded profile of the axle.

7. The force measuring device according to claim 1, characterized in that the electrical conductors are provided in the axle and extending substantially in the axial direction across the entire width of the axle and are contactable axially at every position, preferably in that the axle comprises an axial guide chamber that is furnished with axially running power rails that are contactable at an arbitrary axial position by current collectors in the load cells of the measuring segments and form the said electrical conductors.

8. The force measuring device according to claim 1, characterized in that electrical conductors are provided in each case between adjacent measuring segments and in that only the outermost measuring segment or the outermost measuring segments are connected directly to the evaluation unit, such that the measuring signals are looped through to the evaluation unit via the conductors that connect the measuring segments.

9. The force measuring device according to claim 1, characterized in that the measuring segments each include an electronics unit for feeding the strain gauges and for receiving, for preamplifying, preferably additionally for digitalizing, and for passing the preamplified and, if applicable, digitalized measuring signals to the electrical lines, especially the power rails in the axle.

10. The force measuring device according to claim 1, characterized in that the measuring segments are arranged on the axle in such a way that their roll shells are adjacent practically without gaps without touching each other, preferably in that the roll shells of the measuring segments have the same width.

11. The force measuring device according to claim 1, characterized in that the web tension aggregation means includes a means for storing an assignment of longitudinal strips of a material web to be measured and the measuring segments of the segmented measuring roll, as well as a means for calculating, from the web tension fractions determined by the measuring segments and the stored assignment of the measuring segments to the longitudinal strips to be measured, the total web tension for each of the longitudinal strips to be measured.

12. A system for measuring the web tensions of a plurality of longitudinal strips of a longitudinally cut running material web that comprises a longitudinal direction defined by the running direction of the material web and a transverse direction, having
two or more different material paths for guiding, in each case, one portion of the longitudinal strips of the cut material web in different planes to obtain multiple material subwebs having, in each case, a plurality of spaced apart longitudinal strips, and
two or more force measuring devices according to claim 1 for measuring the web tensions of the plurality of spaced apart longitudinal strips of the material subwebs.

13. A method for measuring the web tensions of a plurality of spaced apart longitudinal strips of a longitudinally cut running material web with a force measuring device according to claim 1, in which
the plurality of spaced apart longitudinal strips of the material web are guided over the segmented measuring roll of the force measuring device in such a way that the spaced apart longitudinal strips wrap around in each case one or more measuring segments, and each measuring segment is wrapped around by at most one longitudinal strip,
the web tension fraction of the longitudinal strip wrapping around the respective measuring segment is determined with the load cells of the measuring segments,
the measuring signals determined by the load cells are routed to the evaluation unit, and the total web tension of the longitudinal strip is determined for each longitudinal strip by the web tension aggregation means from the web tension fractions that were determined by the load cells of the measuring segments wrapped around by said longitudinal strip.

14. The method according to claim 13, in which, to measure the web tensions of the plurality of longitudinal strips of the longitudinally cut running material web, a system according to claim 12 is used,
in each case, a portion of the longitudinal strips of the cut material web being guided along one of the material paths in different planes, such that multiple material subwebs are obtained, having in each case a plurality of spaced apart longitudinal strips, and
the web tensions of the plurality of spaced apart longitudinal strips of the material subwebs are measured with two or more force measuring devices according to claim 1.

15. A force measuring device for measuring the tension profile of an uncut running material web that comprises a longitudinal direction defined by the running direction of the material web and a transverse direction, the force measuring device comprising an axle and, supported on the axle, a measuring roll wrapped around by the material web, in which
the measuring roll is formed as a segmented measuring roll having a plurality of measuring segments,
the measuring segments are arranged on the axle in a respective measuring position,
each measuring segment includes a dedicated load cell for determining a web tension fraction of the longitudinal section of the material web wrapped around the measuring segment, the load cell providing a mount with which the measuring segment sits on the axle,
the force measuring device further comprises an evaluation unit to which the measuring segments are connected via electrical conductors and to which the measuring signals supplied by the load cells of the measuring segments are conductible,
electrical conductors being provided in each case between adjacent measuring segments and only the outermost measuring segment or the outermost measuring segments being connected directly to the evaluation unit, such that the measuring signals are looped through to the evaluation unit via the conductors that connect the measuring segments.

16. The force measuring device according to claim 15, characterized in that the measuring segments comprise, in addition to the load cell, a roll shell and, supported by the load cell, a bearing for the roll shell, and in that the measuring segments are arranged on the axle in such a way that their roll shells are adjacent practically without gaps without touching each other.
